(19) United States
(12) Patent Application Publication
(10) Pub. No.: US 2008/0129859 A1
(43) Pub. Date: Jun. 5, 2008

(54) Focus compensated system for tilted images

(76) Inventor: D. Alexander Koso, Topsfield, MA (US)

Correspondence Address: Iandiorio & Teska, 260 Bear Hill Road, Waltham, MA, 02451-1018, US

(21) Appl. No.: 11/903,404

(22) Filed: Sep. 20, 2007

Related U.S. Application Data
(60) Provisional application No. 60/847,978, filed on Sep. 28, 2006.

(51) Int. Cl. H04N 5/232

(52) U.S. Cl. 348/345; 348/E05.024

(57) ABSTRACT

A focus compensated system for tilted images includes a light source having an illumination device, an object for providing a number of lines of light; and an object lens having an optical axis for projecting the lines on to a part; a camera including a light sensitive element and an image lens having an optical axis for receiving the light reflected from the lines on the part onto the light sensitive element; at least one of the camera and the light source having its optical axis at an angle θ greater than zero to the part and the light sensitive element and the object being correspondingly oriented at an angle φ to its own optical axis where θ and φ are approximately equal.

### RELATED APPLICATIONS

This application claims benefit of and priority to U.S. Provisional Application Ser. No. 60/847,978 filed Sep. 28, 2006 incorporated herein by this reference.

### FIELD OF THE INVENTION

This invention relates to a focus compensated system for tilted images and more particularly to such a system useful in measurement applications.

### BACKGROUND OF THE INVENTION

Using triangulation is common practice for the measurement of distance, e.g. camera range finders. With the development of lasers, systems have been designed to measure distance by projection of a laser spot or line onto a target and observing it in the field of view of a camera. A similar approach has been used for the measurement of solder paste thickness during production of electronic boards where components are attached to the board using surface mount technology (SMT) and a camera viewing the solder pads, for example, provides a measure of the solder thickness. The line across the top of the solder pad is displaced horizontally from the line at the base of the solder pad on the board by an amount which is a function of the laser mounting angle. For example, with an angle of 45° the horizontal displacement is equal to the height of the solder pad. To get a more accurate measure a laser source or other light source may be used that projects a number e.g. five lines across the solder pad. The required accuracy for these measurements is approximately 0.001″To achieve this accuracy, the laser lines can be 0.001′ to 0.002″ wide. The f# of the projection system and thus the depth of field can be high enough to insure that the projected lines are reasonably well focused.

Miniaturization and the use of precious metals have increased the required measurement accuracy from approximately 0.001″ or 0.0005″ to 0.0001″ or 0.00005 (1 to 2 microns). Thus the projected lines have to be substantially narrower than the 0.001″ width used in present solder paste measuring machines. The projection system f# has to decrease to f/3 or f/2 and the resulting small depth of field means that only one of the projected lines is “in focus”. The other lines are defocused and too wide to be used in high accuracy measurements and 0.0001 inches or 2.5 microns closely approaches the theoretical limit of approximately 1.0 microns for lenses using visible light.

### BRIEF SUMMARY OF THE INVENTION

It is therefore an object of this invention to provide an improved focus compensated system for tilted images.

It is a further object of this invention to provide such an improved focus compensated system which provides multiple lines all in focus.

It is a further object of this invention to provide such an improved focus compensated system which allows use of multiple line images for more accurate measurement.

It is a further object of this invention to provide such an improved focus compensated system which allows use of multiple line images for simultaneous measurement of different locations on an object.

It is a further object of this invention to provide such an improved focus compensated system which enables viewing of multiple lines in focus even in cases of specular reflection.

The invention results from the realization that a focus compensated system for tilted images facilitating multiple line measurement can be achieved by orienting the multiple lines object in the light source or the light sensitive element in the camera, or both, at the same angle (incidence) than the optical axis of the light source and/or camera is to the normal to a part to be measured.

The subject invention, however, in other embodiments, need not achieve all these objectives and the claims hereof should not be limited to structures or methods capable of achieving these objectives.

This invention features a focus compensated system for tilted images including a light source having an illumination device, an object for providing a number of lines of light; and an object lens having an optical axis for projecting the lines on to a part. There is a camera including a light sensitive element and an image lens having an optical axis for receiving the light reflected from the lines on the part onto the light sensitive element. At least one of the camera and the light source has its optical axis at an angle θ greater than zero to the part and the light sensitive element and the object are correspondingly oriented at an angle φ to its own optical axis where θ and φ are approximately equal.

In a preferred embodiment the illumination device may include a laser. The illumination device may include at least one LED. The object may include an opaque mask with spaced transparent slits. The light source may have its optical axis at an angle θ greater than zero to the part and the object may be oriented at approximately the angle φ to its optical axis and the camera optical axis may be at an angle of approximately zero. The camera source may have its optical axis at an angle θ greater than zero to the part and the light sensitive element may be oriented at approximately the angle φ to its optical axis and the light sensitive element optical axis may be at an angle of approximately zero. The light source may have its optical axis at an angle θ greater than zero to the part and the object may be oriented at approximately the angle φ to its optical axis and the camera source may have its optical axis at an angle θ greater than zero to the part and the light sensitive element may be oriented at approximately the angle φ to its optical axis.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a three-dimensional schematic view of a prior art system using a single line light source to effect measurement of the thickness of a part;

FIG. 2 is a view similar to FIG. 1 of a prior art system using a multiple line light source;

FIG. 3 is a schematic side elevational view showing the focus problem encountered with the multiple line projection of FIG. 2;

FIG. 4 is a schematic side elevational view showing the focus compensation system for keeping all lines in focus according to this invention where the light source is tilted, and the camera is not;

FIG. 5 is a view similar to FIG. 4 showing the focus compensation system keeping all lines in focus according to this invention where the light source and camera are tilted;

FIG. 6 is a view similar to FIG. 4 showing the focus compensation system keeping all lines in focus according to this invention where the camera is tilted and the light source is not; and

FIG. 7 is a diagram showing the relevant parameters for the mathematical proof of the efficacy of tilting either one or both of the object and image to obtain the improved focus.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

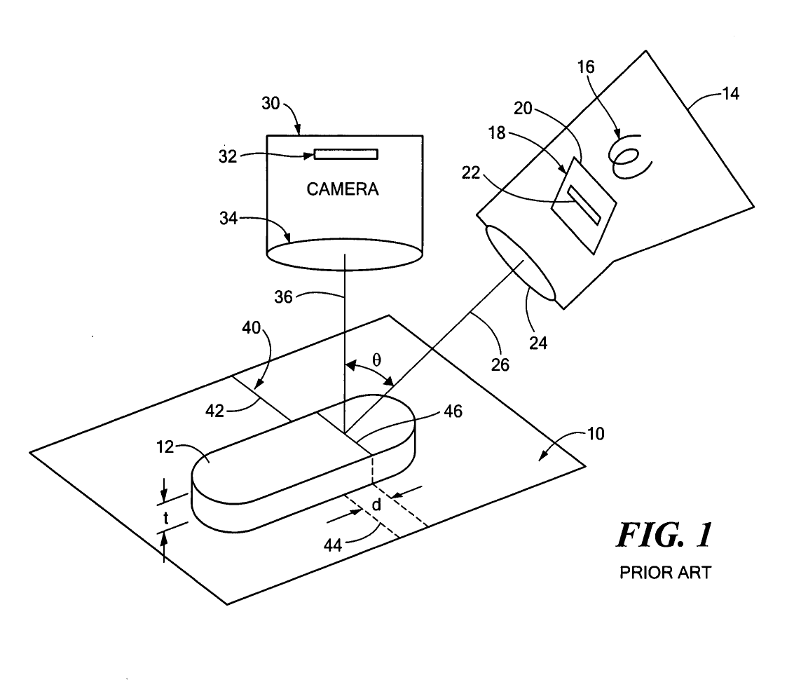

There is shown in FIG. 1 a conventional system for measuring parts of a PC board 10; in this case the part 12 is a spot of solder paste which is non-specular reflecting. The light source 14 contains an illumination device 16 such as conventional light, a laser, or an LED, an object 18 such as a mask 20 containing a slit 22 and an object lens 24 which focuses the line of light from slit 22 onto the PC board 10 and part 12. The optical axis 26 of light source 14 is at an angle of incidence θ to PC board 10 and part 12. There is also a camera 30 which includes a light sensitive element 32 which can be, for example, a CCD or CMOS device and an imaging lens 34. The optical axis 36 of camera 30 is normal to the surface of board 10 and part 12 so the angle of its optical axis is 0. The line of light 40 cast on board 10 and part 12 by object lens 24 appears broken so that the portions 42 and 44 on surface of PC board 10 are displaced horizontally by a distance d from the segment 46 of the line 40 appearing on top of part 12. This is a function of the thickness t of the solder part 12. d is actually a function oft and when the optical axis is at an angle θ equal to 45°, d is equal to t, so the thickness of part 12 can be easily determined with the proper signal processing which is known.

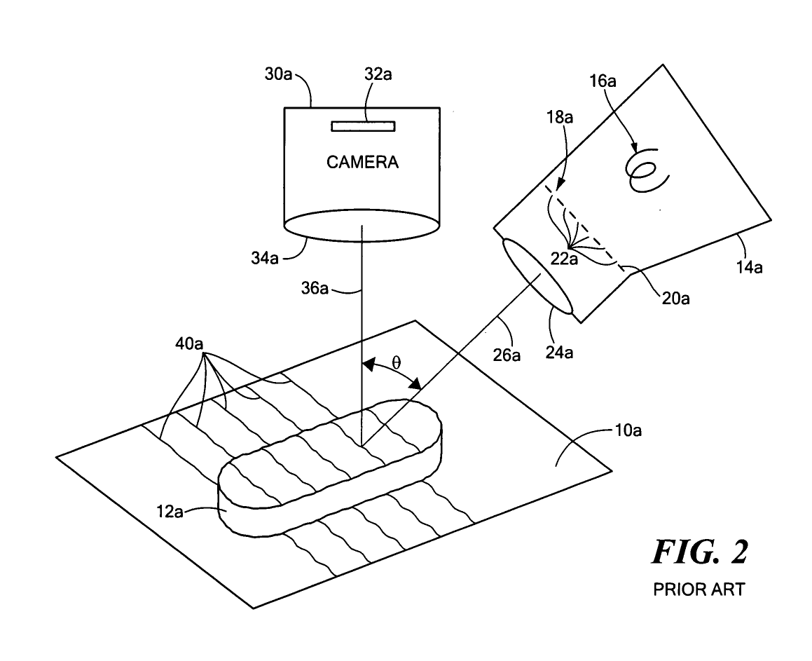

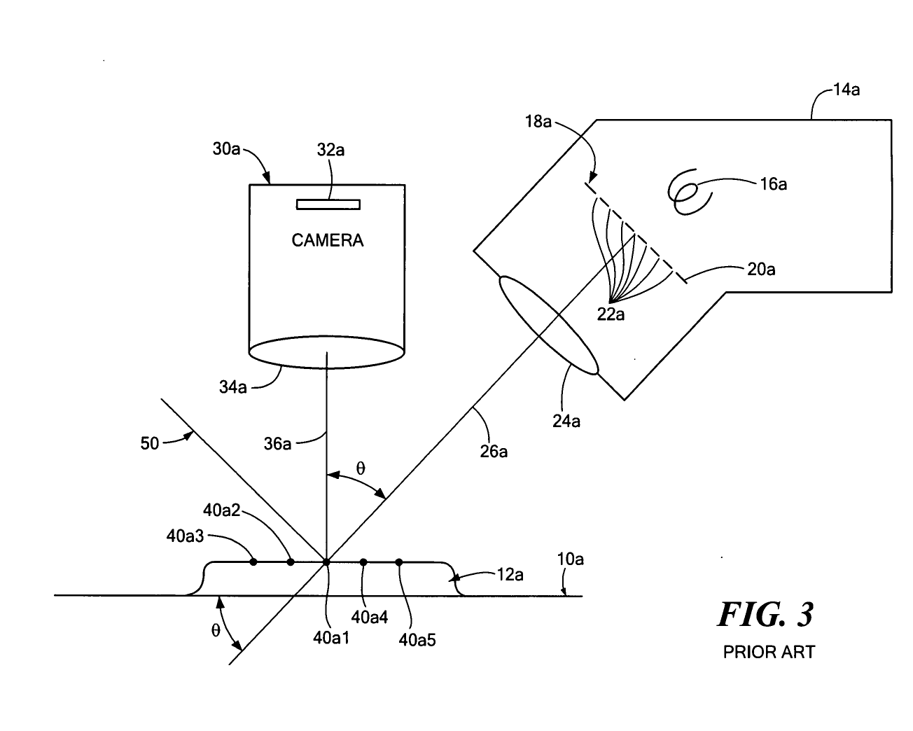

Object 18a, FIG. 2, may include a mask 20a which has a number of slits 22a, e.g. five slits, which produce five lines 48a across PC board 10a and part 12a. As explained previously in the Background of Invention this approach may work well with lower resolution applications but when the measurement accuracy is increased from approximately 0.001″ to 0.00005 to 0.0001″ the projected lines have to be substantially narrower than the 0.001″ used in the present solder paste measuring machines for example. The projection system f# has to decrease to f/3 or f/2 and the resulting small depth of field means that only one of the projected lines will be in focus. The other lines are defocused and too wide to be used in high accuracy measurements. This is illustrated in FIG. 3 where the focal plan is indicated at 50 showing that the center line 40a1 would be in focus whereas the remaining lines 40a2, 40a3, 40a4, and 40a5 would not be in focus. The increased number of lines 40a allows a more accurate assessment of the height and width of part 12a as it may not be uniform throughout its extent. Multiple lines are also useful in the prior art to obtain simultaneous readings from a number of different locations, for example, solder balls which are smaller and occur arrayed in great numbers.

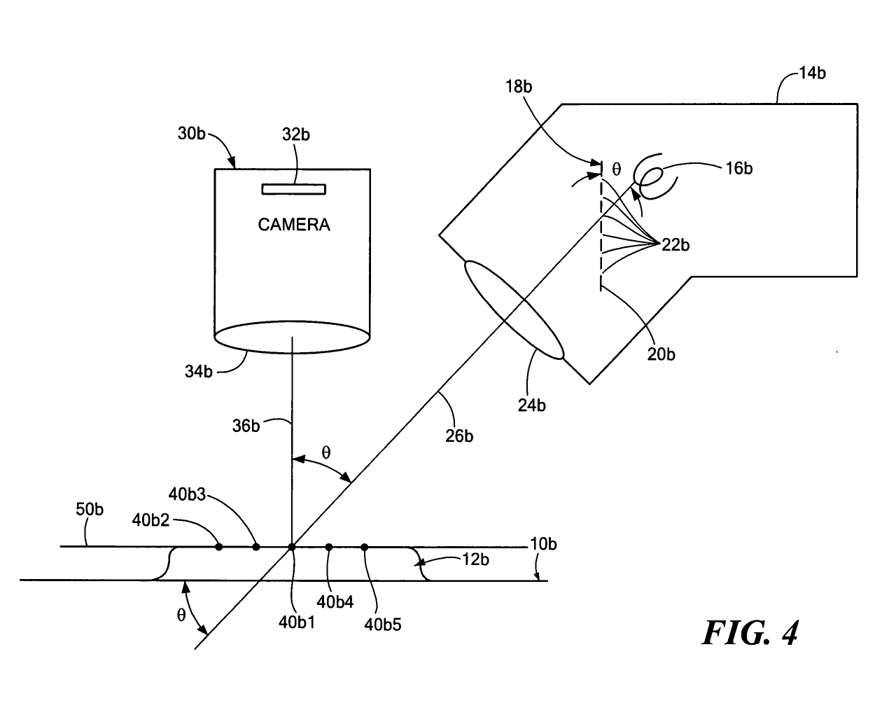

The invention follows from the realization that the focal plane 50b, FIG. 4, for all of the lines 40b1-40b5 can be rotated to lie on the surface of interest by rotating the object 18b, in this case, mask 20b containing the slits 22b by an angle φ ideally equal to the angle of incidence θ of the optical axis 26b. φ is ideally equal to θ for the best and sharpest focus but even an approximation will result in a significant improvement in the sharpness of lines 40b1-40b5 according to this invention.

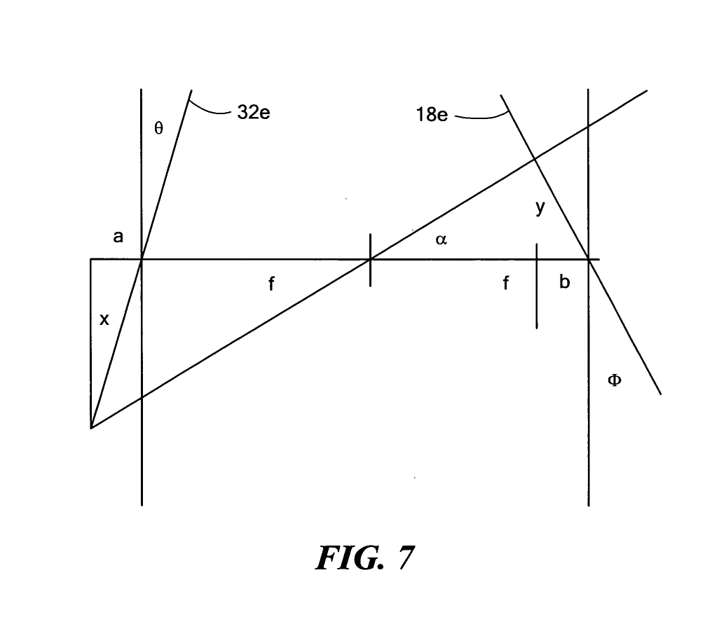

The optical soundness of this approach can be seen from the basic equation for an optical system

$$\frac{1}{u} + \frac{1}{v} = \frac{1}{focal length of lens} \qquad ( 1 )$$

Where ū is the object distance and v is the image distance. In this case operating at 1.1 magnification u=v. However, since the image plane is tilted, u=v is true only at the center of the field of view. Using equation (1) and the geometry of the two tilted focal planes, shown in FIG. 7, (where we use f to represent the distance to the image and also to the object) it can be shown that for all points to be in focus

tan θᵤ=tan φᵥ (2)

is at magnification of 1:1. Thus when the optical axis is at 45°, and the image is horizontal, the object has to be vertical.

So far the invention has been explained with reference to a surface which is non specular. The part used here, part 12, is pre-flowed solder which has a non-specular surface. So although the illuminating light is projected onto the surface to be measured at an angle of incidence greater than zero the camera can view the reflected light normally.

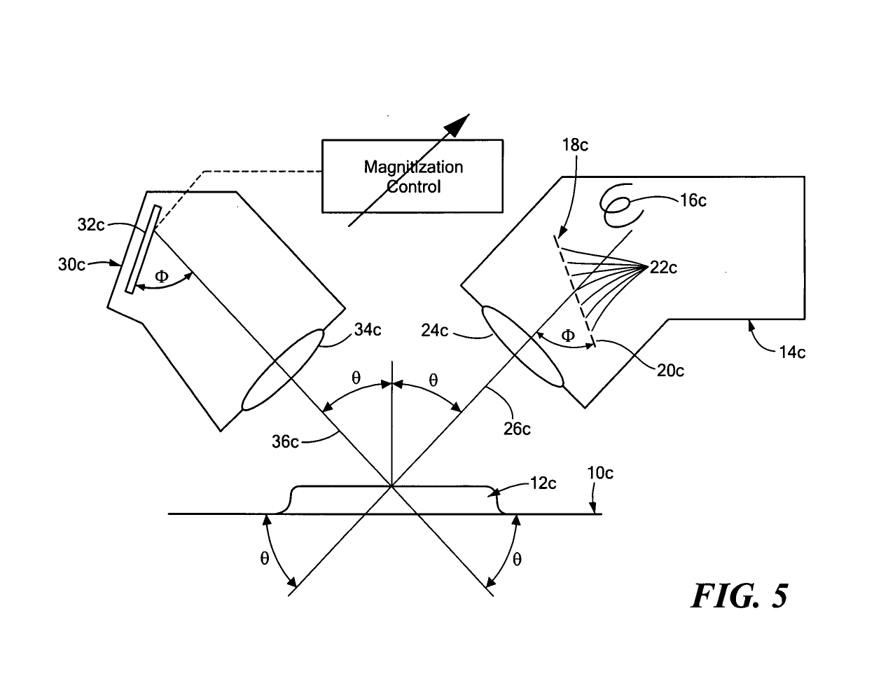

However, if the surface is a specular reflector, for example, Mylar, or some similar material a camera so oriented cannot see the reflected light. In that case the optical axis of the camera will have to be placed at an angle equal to that of the optical axis of the light source. That is the angle of reflection must be equal to the angle of incidence. This is shown in FIG. 5, thus camera 30c has its optical axis 36c at the same angle θ to the normal as does light source 14c. Further the light sensitive element 32c is at the same angle φ to its optical axis as object 18c; mask 20c containing slits 22c is at the same angle θ to its optical axis 26c. Again, ideally, φ is equal to θ but if there are approximately close the results are significantly improved according to this invention. For best results with this invention the magnification is kept at approximately unity. If the magnification varies from that the lines will become a bit fuzzy but still will provide the improvement contemplated by this invention. Note that the tilt required, (φ), varies with magnification. In these illustrations the camera is tilted to be in focus for unity magnification. When the magnification is increased the image quality near the edge of the field of view decreases but still is substantially better than in a system with the light sensitive element mounted normal to the optical axis.

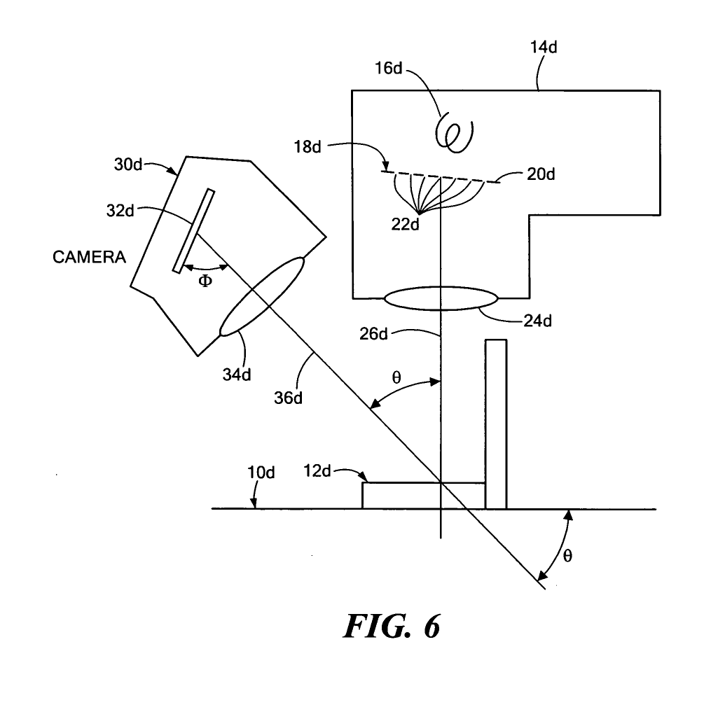

In some cases it is necessary to have the lines projected in a vertical direction such as when the material is in an enclosure with vertical walls or looking at ball grid arrays. In that case the light has to be projected from the vertical and the camera views the surface from an angle. This is shown in FIG. 6, where light source 14d is vertical with the object 18d, mask 20d oriented horizontally and optical axis 26d is normal to the surfaces of PC board 10 and solder 12d to be viewed. Here camera 30d has its optical axis 36d at an angle θ to the normal to those surfaces and its light sensitive element 32d is tilted at an angle φ approximately equal to θ.

The mathematical proof of the efficacy of the invention is shown with respect to the diagram of FIG. 7 and the following series of representative equations.

$$\begin{matrix}\frac{1}{f} + \frac{1}{f} = \frac{2}{f} & ( 3 ) \\ \frac{1}{f + a} + \frac{1}{f - b} = \frac{2}{f} & ( 4 ) \\ \frac{1}{f - b} = \frac{2}{f} - \frac{1}{f + a} = \frac{2 f + 2 a - f}{f ( f + a )} = \frac{f + 2 a}{f ( f + a )} & ( 5 ) \\ 1 = \frac{( f + 2 a ) ( f - b )}{f ( f + a )} ; f ( f + a ) = ( f + 2 a ) ( f - b ) & ( 6 ) \\ \begin{matrix}- b ( f + 2 a ) = f ( f + a ) - f ( f + 2 a ) \\ = {f}^{2} + af - {f}^{2} - 2 af \\ = - af\end{matrix} & ( 7 ) \\ b ( f + 2 a ) = af & ( 8 ) \\ b = \frac{af}{f + 2 a} & ( 9 ) \\ but a = x sin θ & ( 10 ) \\ b = \frac{fx sin θ}{f + 2 x sin θ} & ( 11 )\end{matrix}$$

now take tan α:

$$\begin{matrix}\frac{x cos θ}{f + x sin θ} = \frac{y cos φ}{f - y sin φ} & ( 12 ) \\ y cos φ = \frac{x cos θ ( f - y sin φ )}{f + x sin θ} & ( 13 ) \\ y sin φ = b & ( 14 )\end{matrix}$$

using equation (11)

$$\begin{matrix}\begin{matrix}y cos φ = \frac{x cos θ ( f - \frac{fx sin θ}{f + 2 x sin θ} )}{f + x sin θ} \\ = \frac{x cos θ ( \frac{{f}^{2} + 2 fx sin θ - fx sin θ}{f + 2 x sin θ} )}{f + x sin θ} \\ = \frac{x cos θ ( f ) ( f + x sin θ )}{( f + x sin θ ) ( f + 2 x sin θ )}\end{matrix} & ( 15 ) \\ y cos φ = \frac{fx cos θ}{f + 2 x sin θ} & ( 16 ) \\ b = y sin φ = \frac{fx sin θ}{f + 2 x sin θ} & ( 17 ) \\ tan φ = tan θ & ( 18 )\end{matrix}$$

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A focus compensated system for tilted images comprising:
a light source including an illumination device, an object for providing a number of lines of light; and an object lens having an optical axis for projecting said lines on to a part;
a camera including a light sensitive element and an image lens having an optical axis for receiving the light reflected from the lines on the part onto said light sensitive element;
at least one of said camera and said light source having its optical axis at an angle greater than zero to said part and said light sensitive element and said object being correspondingly oriented at an angle to its own optical axis where and are approximately equal.

2. The focus compensated system of claim 1 in which said illumination device includes a laser.

3. The focus compensated system of claim 1 in which said illumination device includes at least one LED.

4. The focus compensated system of claim 1 in which said object includes an opaque mask with spaced transparent slits.

5. The focus compensated system of claim 1 in which said light source has its optical axis at an angle greater than zero to said part and said object is oriented at approximately said angle to its optical axis and said camera optical axis is at an angle of approximately zero.

6. The focus compensated system of claim 1 in which said camera source has its optical axis at an angle greater than zero to said part and said light sensitive element is oriented at approximately said angle to its optical axis and said light sensitive element optical axis is at an angle of approximately zero.

7. The focus compensated system of claim 1 in which said light source has its optical axis at an angle greater than zero to said part and said object is oriented at approximately said angle to its optical axis and said camera source has its optical axis at an angle greater than zero to said part and said light sensitive element is oriented at approximately said angle to its optical axis.
